(19) United States
(12) Patent Application Publication
(10) Pub. No.: US 2020/0349417 A1
(43) Pub. Date: Nov. 5, 2020

(54) SYSTEMS AND METHODS TO DEMONSTRATE CONFIDENCE AND CERTAINTY IN FEEDFORWARD AI METHODS

(71) Applicant: Tsvi ACHLER, Palo Alto, CA (US)

(72) Inventor: Tsvi ACHLER, Palo Alto, CA (US)

(21) Appl. No.: 16/932,312

(22) Filed: Jul. 17, 2020

Related U.S. Application Data
(63) Continuation of application No. PCT/US2019/013851, filed on Jan. 16, 2019.
(60) Provisional application No. 62/618,084, filed on Jan. 17, 2018.

(51) Int. Cl. G06N 3/04; G06K 9/62

(52) U.S. Cl. CPC G06N 3/0454; G06K 9/6262; G06N 3/0445

(57) ABSTRACT

A computer-implemented method includes obtaining a first neural network trained to recognize one or more patterns; converting said first neural network to a mathematically equivalent second network; and then using said second network to determine one or more factors that influence pattern recognition by said first neural network.

### RELATED APPLICATIONS

This application is a continuation of PCT/US2019/013851, filed Jan. 16, 2019, and published as WO/2019/143725, which claims priority from U.S. provisional patent application No. 62/618,084, filed Jan. 17, 2018, the entire contents of both of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to systems and methods to demonstrate confidence and certainty in various feedforward AI methods from simple regression models to deep convolutional networks and related methods for easier training and updating.

### BACKGROUND

Feedforward artificial intelligence (AI) is AI that uses the mechanism that multiplies weights times inputs in order to perform recognition or inference. Most AI used today is feedforward. In many AI applications a mistake has serious consequences, but feedforward AI is essentially a black box: it is hard to understand what it is looking for. Currently several methods and strategies are used to try to understand what the networks are looking for such as Bayesian methods, simpler networks, decision trees, and varying inputs. However these solutions are not scalable, cannot be accurately applied to large networks, or result in loss of performance.

It is desirable, and an object hereof, to provide a way to determine what AI, especially feedforward AI, is looking for or considering when making its decisions.

### SUMMARY

The present invention is specified in the claims as well as in the below description. Preferred embodiments are particularly specified in the dependent claims and the description of various embodiments.

A system of one or more computers can be configured to perform particular operations or actions by virtue of having software, firmware, hardware, neuromorphic hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method including: obtaining a first neural network trained to recognize one or more patterns; converting said first neural network to an equivalent second neural network; and using at least said second neural network to determine one or more factors that influence recognition of a pattern by said first neural network. Other embodiments of this aspect include corresponding computer systems, apparatus, and computer programs recorded on one or more computer storage devices, each configured to perform the actions of the methods.

Implementations may include one or more of the following features. The method where the first neural network is a multilayered network including a plurality of layers. The method where the second neural network includes the same number of layers as the first neural network. The method where the first neural network includes a feedforward network. The method where the second neural network includes a feedforward-feedback network. The method where the first network includes a first number of input modules, a second number of output modules, and a third number of feed-forward connectors, and where the second neural network includes a fourth number of input modules, a fifth number of output modules, and a sixth number of feed-forward/feedback connectors, where the first number is equal to the fourth number, and the second number is equal to the fifth number, and the third number is equal to the sixth number. The method where the first network includes a seventh number of nonlinearities between layers of the first network, and where the second neural network includes an eighth number of nonlinearities between layers of the second neural network, and where the seventh number is equal to the eighth number. The method where said converting includes: for each connection of the first network having a feedforward weight, forming, in the second neural network, a corresponding connection having a corresponding feedforward-feedback weight pair. The method where said using includes: using the second neural network's weights to iterate between feedforward and feedback until recognition of said pattern is complete, producing a desired recognition state. The method where said using further includes: using the first network's weights to perform recognition of said pattern. The method further including: determining expected input activity using said desired recognition state and one or more weights on said second neural network. The method further including: determining an expected pattern for a particular node. The method where said using includes determining one or more of: (i) one or more expected inputs that were not found; and (ii) one or more present inputs that were not expected. The method where the second neural network includes: one or more input modules, one or more output modules, and one or more feed-forward connectors, and one or more feedback connectors, where said one or more input modules are each adapted: (a) to receive and store input information received from sensors, (b) to receive back-transmitted output information from one or more feed-back connectors, (c) to modulate the input information using back-transmitted information to form modulated input information, (d) to forward-transmit the modulated input information using said one or more feed-forward connectors to said one or more output modules; where said one or more output modules are each adapted: (a) to store output information as stored output information, (b) to receive modulated input information forward-transmitted by one or more feed-forward connectors, (c) to modulate the stored output information using forward-transmitted information received from one or more feed-forward connectors, (d) to store the modulated output information as output information, and (d) to back-transmit the modulated output information using one or more feed-back connectors to said one or more input modules; where each of the one or more feed-forward connectors modifies and transmits modulated input information as forward-transmitted information from one of the one or more input modules to one of the one or more output modules, and where each feed-forward connector is associated with a feed-forward connector weight used to modify the information transmitted; and where each of the one or more feed-back connectors modifies and transmits modulated output information as back-transmitted information from one of the one or more output modules to one of the one or more input modules, where each of the feed-back connectors is associated with a feed-back connector weight that is used to modify the information transmitted.

The method where the second neural network is mathematically equivalent to the first neural network.

One general aspect includes an article of manufacture including non-transitory computer-readable media having computer-readable instructions stored thereon, the computer-readable instructions including instructions for implementing a computer-implemented method, said method operable on a device including hardware including memory and at least one processor and running a service on said hardware, said method including the method of any of the above aspects.

One general aspect includes a system including: (a) hardware including memory and at least one processor, and (b) a service running on said hardware, where said service is configured to: perform the method of any of the above aspects.

Implementations of the described techniques may include hardware, a method or process, or computer software on a computer-accessible medium.

One general aspect includes a recognition device having hardware, including at least one processor and associated memory, the device including: a network including one or more input modules, one or more output modules, and one or more feed-forward connectors, where the one or more input modules are each adapted: (a) to receive and store input information received from sensors, (b) to receive back-transmitted output information from one or more feed-back connectors, (c) to modulate the input information using back-transmitted information to form modulated input information, (d) to forward-transmit the modulated input information using the one or more feed-forward connectors to the one or more output modules; where the one or more output modules are each adapted: (a) to store output information as stored output information, (b) to receive modulated input information forward-transmitted by one or more feed-forward connectors, (c) to modulate the stored output information using forward-transmitted information received from one or more feed-forward connectors, (d) to store the modulated output information as output information, and (e) to back-transmit the modulated output information using one or more feed-back connectors to the one or more input modules; where each of the one or more feed-forward connectors modifies and transmits modulated input information as forward-transmitted information from one of the one or more input modules to one of the one or more output modules, and where each feed-forward connector is associated with a feed-forward connector weight used to modify the information transmitted; and where each of the one or more feed-back connectors modifies and transmits modulated output information as back-transmitted information from one of the one or more output modules to one of the one or more input modules, where each of the feed-back connectors is associated with a feed-back connector weight that is used to modify the information transmitted. Other embodiments of this aspect include corresponding computer systems, apparatus, and computer programs recorded on one or more computer storage devices, each configured to perform the actions of the methods.

Implementations may include one or more of the following features. The recognition device where completion of operations includes a cycle, and where the device repeats these cycles, and where the recognition device is further constructed and adapted: to calculate a state of a current cycle with a component to sum one or more of: (i) the input module modified information for all inputs; or (ii) the output module modified information for all outputs; or (iii) the module modified information; and to store the state of the current cycle; and to compare the state of the current cycle with a stored state of a previous cycle; and to stop the device if a change between the state of the current cycle with a stored state of a previous cycle is less than a threshold. The recognition device further constructed and adapted to store weights of feedback connectors that back-transmit information from an individual output module, where the stored weights are is used to indicate sensor input values suited for that individual output module. The recognition device further constructed and adapted: to calculate a sum of the back-transmitted output information received by an individual input module, to compare input information received by sensors of the same input module with the sum of the back-transmitted output information, to determine if a first sum of the back-transmitted output information received is greater than sensor information, and, based on whether the first sum of the back-transmitted output information received is greater than sensor information, to indicate that an input was expected and not adequately found in the sensors, to determine if a second sum of the back-transmitted output information received is less than sensor information, and, based on whether the second sum of the back-transmitted output information received is less than sensor information, to indicate that an input was not expected in the sensors, and to determine if a third sum of the back-transmitted output information received is equivalent to sensor information, and, based on the third sum of the back-transmitted output information received is equivalent to sensor information, to indicate that an input was expected and found in the sensors. The recognition device further constructed and adapted: to learn or modify (a) an existing association, or (b) add a new recognition category with a new output node, or (c) add a new input sensor modularly, without modifying existing weights of the device that do not directly connect to the new input sensor or new output node, and to modify an existing forward-transmitting connector from input and its associated existing back-transmitting connector with an updated association; or to add a new non-existing output module with (a) associated new forward-transmitting connector from input (b) associated new back-transmitting connector to same input; or to add a new input node with (a) associated new back-transmitting connector from output (b) associated new forward-transmitting connector to same output. The recognition device further including: a labeled data set with associated input patterns, where: data for each label is averaged to form a calculated average, and an output node is created for each label, and weights of feedback and feedforward mechanisms transmitting between that output node are determined by the calculated average. The recognition device including: a first layer which receives inputs from sensors, one or more intermediate layers which receive a output of a previous layer as sensor input for the intermediate layer, and a top layer that serves as outputs of the network. The recognition device where: the inputs are arranged in a manner that allows a smaller array of inputs to spatially sample a subspace of a larger input set, and where the smaller array is repetitively tiled throughout a larger array of inputs, and where the next layer is used to tile spatial inputs. The recognition device including: a connection to transmit modulated input information from the layer above to the output module of the layer below using one or more feed-back connectors, where output modules of the layer below modulate the output information based on information obtained from one or more feed-back connectors form the input layer above. The recognition device where one or more inputs or layers are configured in a manner to allow recognition of movement or sequences in time. The recognition device where one or more layers delay processing in time to retain activation of a previous state, and where one or more layers with input sensors combine retained activation of one or more layers representing delayed information. Implementations of the described techniques may include hardware, a method or process, or computer software on a computer-accessible medium.

One general aspect includes a computer-implemented method including: obtaining a first neural network trained to recognize one or more patterns; converting the first neural network to a mathematically equivalent second network; and using the second network to determine one or more factors that influence pattern recognition by the first neural network. Other embodiments of this aspect include corresponding computer systems, apparatus, and computer programs recorded on one or more computer storage devices, each configured to perform the actions of the methods.

In some general aspects hereof, the invention provides a way to reveal the underlying patterns that feedforward AI is looking for. In some aspects, the process to reveal the underlying patterns may convert the existing feedforward AI to a form of AI according to exemplary embodiments hereof. One exemplary form gives equivalent performance without loss and reveals why the network makes its decisions.

In some general aspects hereof, the invention is an AI system that is better able to provide its internal state for explanations of what it is considering. Aspects hereof include a method to convert trained AI to another form, according to exemplary embodiments hereof, that is mathematically equivalent to the original AI and provides the same output but now can provide explanations of which inputs are important or less important for the decision.

In some general aspects hereof, the invention is an AI system that is better able to learn life-like manner without the need to rehearsal found in prior art. Aspects hereof include a method to convert train directly into the invention form, according to exemplary embodiments hereof.

Exemplary embodiments hereof may include or support one or more of the following:
allowing real value local expectation weights (M) to be used for recognition.
modelling recall directly from neural networks that perform recognition.
are more computationally efficient than prior art because they do not have to rehearse over training set.
does not require inefficient Independent and Identically Distributed (iid) training paradigm
is easier to update because of its local properties
can use a serial timeline
does not suffer from catastrophic interference
can convert prior art global weights to local weights
can convert local weights to prior art global weights
provides tools for users and developers to understand recognition and modify weights
can use recall in conjunction with update to have human-like learning and refining of recognition
can have multiple versions (e.g. shunting vs. subtractive inhibition)
provides error signal for attention (E) during recognition
allows control of priming
implements abduction and explaining-away logic
Allow for ways to evaluate confidence in the explanation based on new information:

A skilled reader will understand, that any method described above or below and/or claimed and described as a sequence of steps or acts is not restrictive in the sense of the order of steps or acts.

The above features, along with additional details of the invention, are described further in the examples herein, which are intended to further illustrate the invention but are not intended to limit its scope in any way.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows aspects of converting a feed-forward AI network to an equivalent network according to exemplary embodiments hereof;

FIG. 2 depicts aspects of an example showing the AI was expected to learn digits but instead learned odd patterns specific to the data set.

FIG. 3 depicts a comparison table between discriminative feedforward prior art and methods according to exemplary embodiments hereof, both during learning and during recognition.

FIG. 4 depicts aspects of a weighted impact-histogram revealing factors contribute to a decision along with a report generated according to exemplary embodiments hereof.

FIG. 5 depicts information derived from exemplary embodiments hereof and graphed showing what is expected and what modifications are necessary to change the decision.

FIG. 6 depicts aspects of impact-histograms allowing cases to be easily compared and understood according to exemplary embodiments hereof.

FIG. 7 depicts aspects of an explanation of convolution layers applied to multiple channels and filters of multi-layer deep convolutions, and using uncertainty information when searching for regions that may be responsible for errors.

FIG. 8A shows aspects of a simple learning presentation sequence that violates iid criteria; FIG. 8B shows aspects of a corresponding iid rehearsing schedule required to incorporate the new instances into feedforward weights; and FIG. 8C depicts aspects of a learning example.

Detailed Description of the Presently Preferred Exemplary Embodiments

### Glossary

As used herein, the following terms/abbreviations have the following meaning, unless otherwise noted:

“AI” means artificial intelligence

“IID” (or “iid”) means Independent and Identically Distributed

The term “mechanism,” as used herein, refers to any device(s), process(es), service(s), or combination thereof. A mechanism may be implemented in hardware, software, firmware, using a special-purpose device, or any combination thereof. A mechanism may be mechanical or electrical or a combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

### Discussion

The present invention is described with reference to embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

I describe a unique and efficient solution around the black box problem that reveals the ground-truth, without guessing, the patterns the network is looking for. One option of using the embodiments hereof, developers may design their AI in a conventional black box feedforward architecture and convert the AI to an illuminated form, enabling better understanding: increasing confidence and decreasing mishaps. Another option of using the embodiments hereof, developers or users may train directly in the illuminated form using novel method that does not require strict rehearsal paradigm compared to prior art. I first describe the conversion process then the learning process.

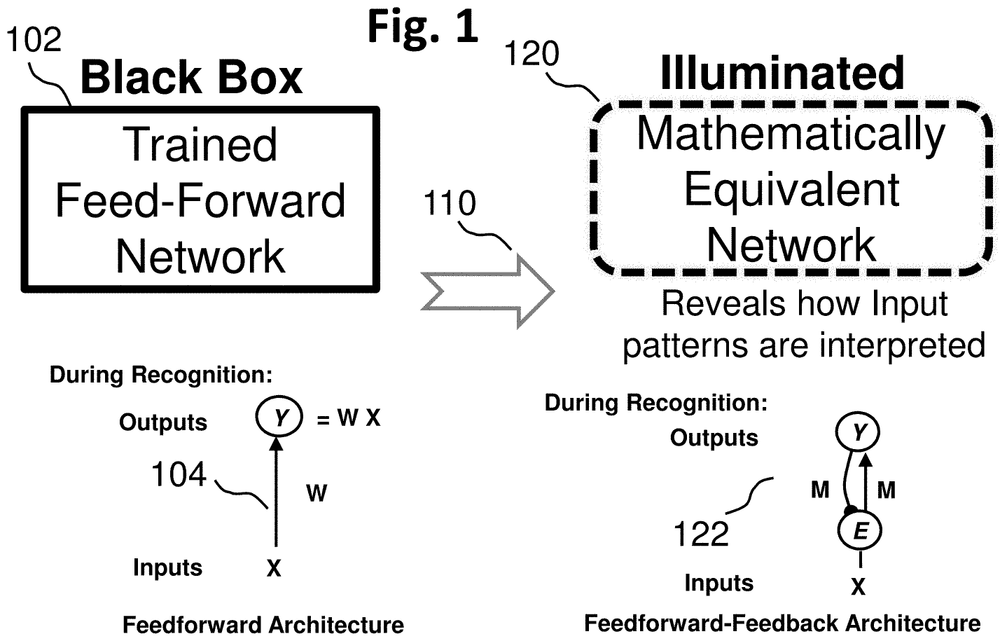

FIG. 1 depicts aspects of converting existing AI to an equivalent network, according to exemplary embodiments hereof. With reference to FIG. 1, the first step (110) is to “illuminate” the existing black box feedforward AI (102) and architecture within (104): to convert the network to be explained into a mathematically equivalent AI (120) and architecture (122) according to exemplary embodiments hereof. The conversion (120) reveals the ground truth: the patterns each node is actually looking for. No trial and error searching is required. Moreover this conversion process embodied in the invention (120) is required only once per model and is fast. After the conversion many inputs can be tested quickly.

The second step, according to exemplary embodiments hereof, explains which inputs are most important for the decision the AI makes. Users can take problematic inputs, frustrating ones that give the wrong answer, and see which parts of the inputs were miss-classified by the network. This is achieved by running inputs within the illuminated RFN network (204,208). The Illuminated form reveals the interpretation of every input component by each node. No trial and error searching is required.

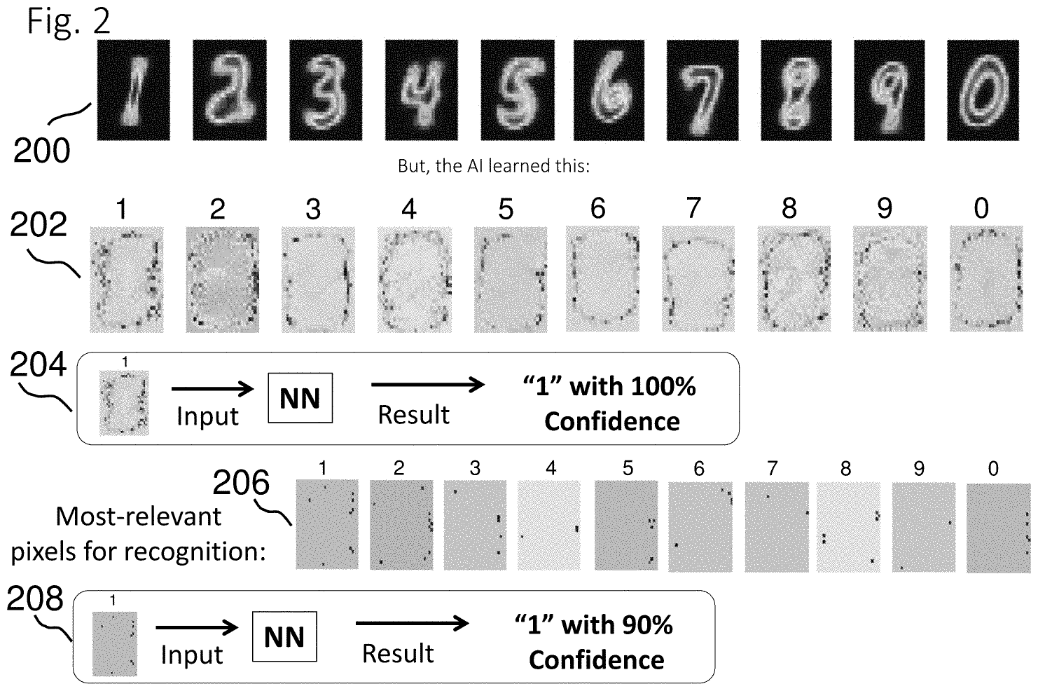

To demonstrate the ease of use, consider a network trained on MNIST data and explain it (FIG. 2). As is well known, the MNIST database (Modified National Institute of Standards and Technology database) is a large database of handwritten digits that is commonly used for training various image processing systems.

A single-layer neural network is trained using publicly-available Scikit learn package. We demonstrate the first step by illuminating the trained neural network. We expect it will look like an average digit obtained from the data set (200). However the optimal patterns for the trained neural network are shown with the labels (FIG. 2: 202). Surprisingly, the optimal patterns do not look anything like the digits (200). The optimal patterns were not derived by trial and error; they are the ground truth learned by the feedforward network.

When these patterns are presented as inputs either to the original or illuminated network, they recognize the label below with 100% confidence, proving they are optimal (204).

Showing an even more extreme demonstration, using the patterns (202) we chose a small number of pixels, sufficient to recognize the digits with significant certainty. The patterns are shown (FIG. 2: 206).

When these patterns are presented as inputs either to the original or illuminated network, they recognize the label above with strong confidence (208). This means the original neural network learned unexpected patterns which do not resemble digits. Obviously, releasing this digit detector in an application will be vulnerable to unexpected errors.

Through this process any arbitrarily activation of the neural network can be created by the combination of the basis patterns shown in FIG. 2, 202.

The invention can help developers debug and validate AI solutions without guessing, and show customers why they can trust their product. Another embodiment is to help regulators speed through regulatory approvals and know if the AI is ready for safety-critical applications; saving time, reducing costs and potentially embarrassing consequences.

### Learning and Recognition with and without Optimization

Learning for recognition methods is defined as the process of determining and storing connection weights. Learning may or may not involve optimization. Learning can be implemented for example by simply averaging the number of times a stimulus is present when a particular label is given.

Optimization is the process of trying something, evaluating it, generating an error, using that error to modify a parameter in the network, then try again, generate again then modify again, repeatedly. Subsequently optimization is a mechanism that iteratively optimizes a system towards achieving a goal by minimizing error or a cost function. It involves comparing a desired state with the current state, generating an error, modifying the network (either by determining neuron weights or neuron activation), comparing again, and moving towards a state with the lowest error.

Prior art feedforward methods use optimization such as backpropagation during learning. Error or a cost function is involved in determining connection weights. Backpropagation forms the basis of feedforward networks, projects error down to the inputs, and uses this error to adjust connection weights during learning.

The invention is different because it projects information down to the inputs during recognition. While this projection can also be used to generate an error signal, it is during recognition and it is not used to modify weights.

Recognition with and without Optimization

Recognition is the process of determining neuron activation given an input pattern. The neuron activation determines the pattern recognized. Like learning, recognition may or may not involve optimization. During recognition feedforward methods do not perform optimization during recognition they do not generate error signals or propagate them back to inputs.

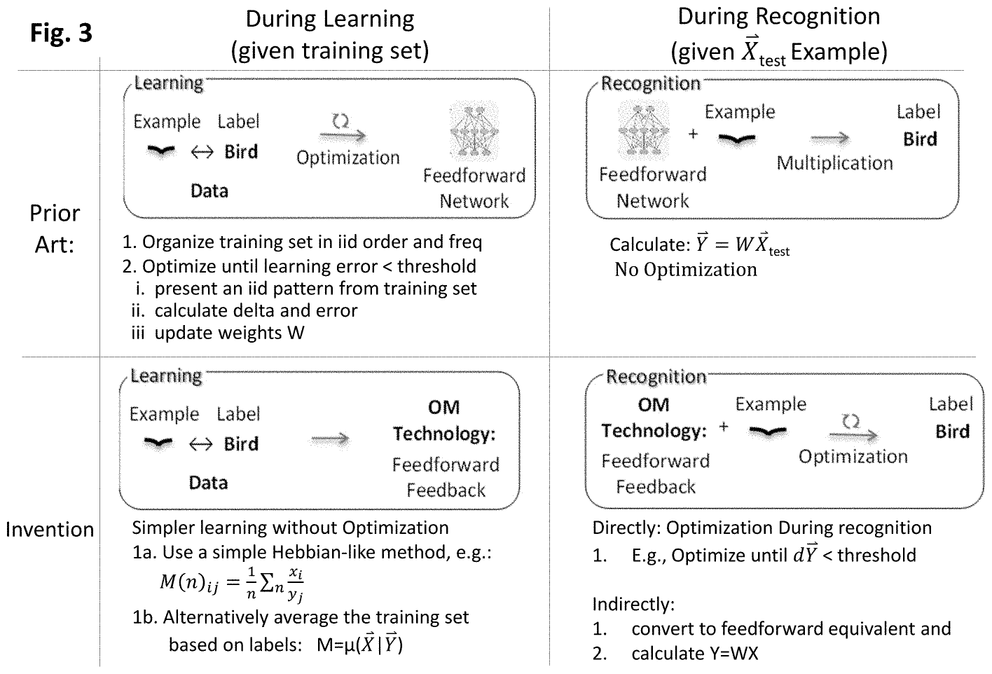

In our method optimization does not occur during learning, but rather it occurs during recognition. The goal of the optimization during recognition is not to find weights but to determine neuron activation. An error signal gets generated at every input and the neurons adjust activation to minimize the error. The error is generated when the model compares the internally generated inputs with the input to be recognized. See FIG. 3 for summary.

Problems with Prior Art AI Learning

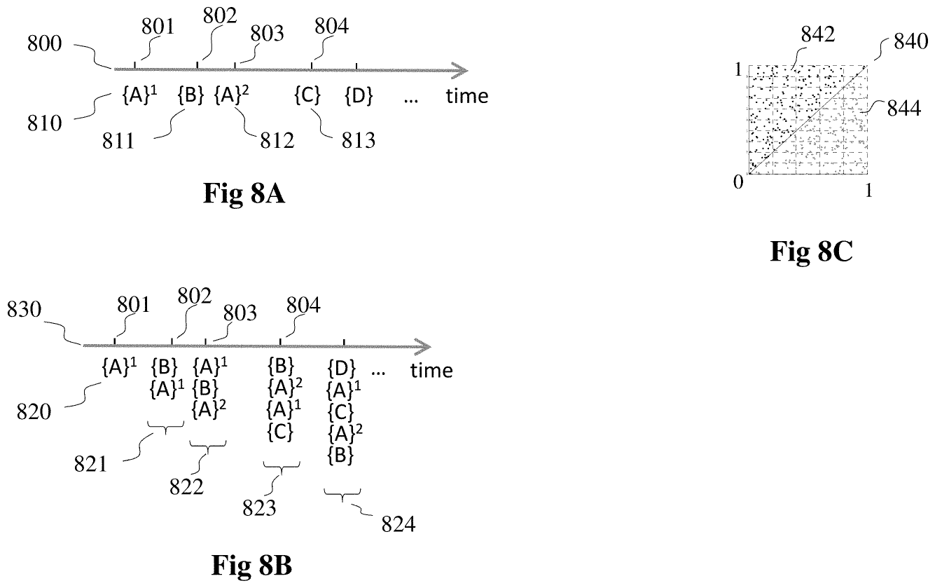

The reason optimization is required to learn feedforward weights in traditional AI is to include all of the information necessary to perform recognition with one pass through feedforward neurons. To recognize correctly feedforward synaptic weights must incorporate how important each input is to each neuron compared to other neurons, what we call uniqueness information. This may not sound too problematic until one realizes that in order to obtain this information, the learning algorithms associated with feedforward methods must use all the patterns in the training set to perform the optimization. This globalist strategy (discussed later) potentially means every pattern ever seen must be stored, then retrieved and rehearsed during learning. Moreover, the training set patterns need to be repeatedly rehearsed in an Independent and Identically Distributed (iid) order to correctly determine the feedforward weights. These training samples are presented in fixed frequencies and random order (FIGS. 8A-8C). In other words information must be carefully interleaved with all the other information in the network otherwise old information can be lost through a process called catastrophic interference and forgetting (McCloskey and Cohen 1989; McClelland et al 1995).

The iid criterion makes it difficult to quickly incorporate new information into the network as the organism encounters it. Any time a new piece of information needs to be learned, the new information must be trained with old information otherwise old information will be lost.

To demonstrate the iid problem in flexible life like learning let patterns A . . . Z represent a sample of the patterns that may be encountered. In the timeline depicted by FIG. 8A, labeled patterns are encountered serially. Pattern A is encountered then pattern B is encountered a few days later and so on.

With reference to FIG. 8A: Simple learning presentation sequence that violates iid criteria. A Time line is depicted in the figure represented by 800. Each mark 801-804 represents the time of appearance of a pattern to be learned. The letter represents a label of that pattern e.g. 810-813. Patterns 810 and 812 represent instances of a pattern with the same label {A}. For example 810 and 812 can be two different versions of {A}.

With reference to 8B: Corresponding iid rehearsing schedule required to incorporate the new instances into feedforward weights. For the appearance of the same patterns in the timeline 801-804, the prior art must be trained on the old and new patterns in the training sets of 820-823 in iid form. For example suppose the patterns in set 821 are learned, and then pattern 812 arrives at time 803, for prior art all the old and new patterns in set 822 have to be relearned in iid form. Even if pattern 812 is another instance of a previously learned pattern e.g. 810, the whole set must be re-learned and rehearsed. iid criteria requires that all of the patterns within the set be rehearsed in the same frequency and random order, error generated, propagated to the inputs, and weights adjusted until the network converges to correctly recognize the patterns in the training set. This must be repeated again from the beginning at time 804 when pattern 813 arrives. All of the old patterns and the new pattern must be retrained in iid form. Moreover the more patterns in the training set, the more difficult and longer the learning. Thus learning in a serial timeline is difficult (unrealistic) using prior art.

Since a life-like environment cannot be assumed to be iid, all previous samples need to be rehearsed. Suppose A is learned and then B is encountered. For the network to learn patterns A and B they must be presented to neurons learning via optimization in iid form. This means A and B must appear many times and in random order and at fixed frequencies. Since the environment only supplied A and B once, the rehearsal of A and B must be internally generated until the network learns satisfactorily. Moreover this rehearsal must be generated in iid form. That means that during optimization the network cannot be internally presented with A-A-A-A-A-A-B-B-B while learning. The order of A's and B's must be random and there must be approximately the same number of A's as there are B's. Thus internal iid rehearsing must look more like A-B-A-B-A-A-B-A-B-B-A.

If the network knows A, B, C, D and now needs to learn E, the same applies. The following rehearsal is not valid: A-A-A-B-C-C-C-C-D-E. iid rehearsal would have to be random in order and at fixed frequencies e.g. D-A-E-C-B-D-A-B-C-E. Such sequences must be randomly chosen and rehearsed until the network satisfactorily learns.

Note that sequences produced for the iid criteria have nothing to do with sequence learning. Sequence learning using feedforward methods would require sequences to be rehearsed at fixed frequencies and in random order. In other words in feedforward sequence learning each pattern A, B, C etc. would be a separate sequence and those sequences need to be played back in iid form shown above.

A significant problem with this approach is that the amount of time required for rehearsing and learning increases nonlinearly as the number of patterns increase. If a network stores 10,000 patterns, then they all have to be rehearsed again for the 10,001-st pattern to be added. Since new patterns can be learned immediately in the brain this means that all of the patterns need to be rehearsed immediately in order to both recognize the new pattern and the old patterns. This reveals a fundamental scalability problem. If massive feedforward networks are used, during recognition, then all of the connections may have to change for a new piece of information learned. Any slight modification in expectation may require changes in thousands or millions of entries in weights. Changes would have to occur immediately in order to instantaneously learn and use that information.

Comparison with Prior Art of Online Learning

A more lifelike learning is attempted in prior art with slow gradual learning with online learning and stochastic gradient descent (Bottou and LeCun 2004). Instead of explicit rehearsing all at once in a batch, the environment is assumed to be iid to allow gradual online learning.

But the iid is a strong requirement that is easily broken in most environments as shown in FIGS. 8A-8B. Moreover, any scenario that changes the environment (which patterns repeatedly occur in the environment) would violate iid. If recognition requires online learning then spending the winter at home or being incarcerated for an extended period of time should make recognizing outdoor scenes difficult. Online methods would forget how to recognize outdoor scenes or missed loved ones. Moreover, online learning does not change the fact that weights may eventually change extensively even with a small change in a pattern.

Other prior art uses hybrid feedforward and Bayesian network to address one-shot learning. Bayesian networks are used in a limited fashion in the top layer (Fei-Fei et al 2006). Bayesian networks are not used throughout the networks, as they are not as scalable as other machine learning methods. For a large amount of patterns scalability becomes difficult. The learning embodied is not bound by iid limits and is scalable.

### Solutions

The root of these difficulties is that feedforward weights are not directly based on expectations and requires global learning and distributed weights. A more-optimal solution is to perform recognition directly based on expectations. Storing and computing information based on expectation allows localized modification of weights and avoids the learning difficulties associated with distributed modification. In other words, in a network directly based on expectations, a modification of expectation will only require local changes in the expectation. Thus a recognition method based on expectation would be simpler to modify based on a serial timeline than a method based on feedforward weights.

The solution distributes computational costs spread more evenly between recognition and learning. This involves performing more-complex computations during recognition and reducing the complexity of computations during learning. With simpler computations during learning, it is less expensive to learn, update and modify the network. This strategy is informed by the enormous number of feedback connections found in the brain and their integrated involvement during recognition.

Instead of optimizing during learning over the training set, the invention optimizes during recognition over the current input to be recognized.

To better understand the difference between optimization during learning and during recognition lets briefly review: 1) learning with and without optimization and 2) recognition with and without optimization.

### Nomenclature

Network notation remains the same regardless of whether optimization is performed during recognition or during learning. Let vector [symbol] represent the activity of a set of output neurons. Let vector [symbol] represent the sensory inputs formed by early sensory neurons. These sensory inputs sample the environment, or input to be recognized

In feedfoward methods, weights W solve the following during recognition:

[symbol]

=W [symbol] or [symbol] =f(W, [symbol] ) (Eq. 1)

The fundamental difference between feedforward and the proposed feedforward-feedback network architecture of the invention is shown in FIGS. 1, 3. In contrast to a feedforward information flow recognizing using feedforward weights, recognition in the invention is achieved with feedforward-feedback weights. Information is spread from inputs to outputs then back to inputs, generates error E, then back again to outputs until optimized output activities are determined. This optimization occurs during recognition and no weights are learned.

We describe feedforward-feedback weights M. M can be learned through a simple Hebbian-like method. M is used directly as weights that implement the optimization.

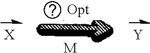

M is expectation weights which allow easy update
Recognition (finding Y) is achieved with optimization using weights M.

A major difference between feedforward networks and the invention is how uniqueness is evaluated and encoded. In the invention neurons do not encode uniqueness within their weights, but calculate uniqueness during recognition. In contrast, feedforward networks solve recognition with one multiplication. In order to recognize correctly within one multiplication, they encode uniqueness information in the weights (more than just an association between inputs and outputs). They learn patterns and incorporate how relevant (unique) each input is. Thus feedforward weights depend on how relevant (unique) each input is. Accordingly, weights rely on input and output nodes other than the immediate input and output node that the weight connects to, making updating difficult.

Invention neurons avoid iid requirements since they optimize only using the current pattern that is being recognized: X. Thus instead of learning weights by optimizing over the whole training set, a simple-Hebbian-like relational learning is sufficient without any uniqueness information. As an example, this allows learning of an expected pattern for zebra (e.g.: typical zebras have 4 legs, 2 eyes, stripes, etc.). When learning the expectation, it doesn't matter whether other animals also exist that use the same input (and may also have 4 legs such as dogs, cats, rats, giraffes, etc., or may have 0, 2, 6, 8 or any other number of legs). The weights between zebra and leg input features are more symbolic (discussed later) and remain the same regardless of the other nodes. The same is true with zebra and stripes or any other feature.

However stripes are essential when distinguishing between zebras and other 4 legged animals since zebras are very distinctive (among 4 legged animals) in that they have stripes. Subsequently stripes may be more important for recognizing zebras than many other features such as ears, eyes etc. An elevated status of unique information (such as stripes) is needed to properly perform efficient recognition regardless whether the network is feedforward or Illuminated. The difference is that feedforward networks determine this importance during learning, and the invention determines this importance during recognition.

The optimization iteratively: 1) determines the importance of each input based on feedback; 2) adjusts the inputs' relevance to the network; and 3) determines network activation. This optimization mechanism is achieved using neurons that activate and inhibit each other using feedforward-feedback connections.

There are several benefits of optimization during recognition. The first is that there is only one pattern to optimize during recognition: the current input. This saves a lot of computational resources, simplifies learning, and avoids expensive re-training requirements for updates.

Another benefit is that weights in this form represent the patterns that the network is looking for, allowing the network to be explainable.

Information in this form also allows modification of individual neurons with selective plasticity (allowing the rest of the neurons to remain the same), avoiding global (network-wide) modification requiring optimization and rehearsal in iid form.

Recall and Explainability

Although predominant prior art recognition algorithms can recognize, their internal memory is opaque—a black box, making them hard to recall, modify, and fine tune. Memory weights of each memory that represents a pattern depend on other patterns learned that are not directly associated with that memory. This type of weights and learning is referred to as global. To learn global weights, an optimization algorithm (a mechanism that iteratively and progressively minimizes of error) such as backprop is used, which also makes it computationally costly to change memory: to add, edit, or remove individual memories.

Thus several drawbacks occur with global learning methods: 1) As discussed in the previous section when new information is presented a new set of iterations are needed to minimize error and learn. These iterations can take a significant amount of time and the amount iterations needed increases with the number of memory patterns (previous information stored) in the network. Thus learning new patterns individually as they appear is difficult. 2) Memory weights learned by such methods are not easily recallable (it is not easy to infer from the weights the patterns stored in the network). The ability to recall memory is essential for intelligence: performing logic and reasoning.

Using the invention, it is easier to recall and change internal memory making it easier to envision, add, edit, and remove memories. This is because symbolic relations are lost in the optimization process of learning feedforward weights.

Localist Learning

In very early prior art known simple Hebbian learning (as opposed to later distinctions), each node only learns direct information about its own inputs: thus is referred to as local learning, does not encode uniqueness (importance) information into memory weights, and is easier to recall. To designate the differences between the weights, feedforward weights are referred to as W and the Hebbian-type weights as M. Using Hebb's method, learning synaptic weights Mᵢⱼ of a neuron j with input xᵢ and output yⱼ are calculated as follows:

ΔMᵢⱼ=ηxᵢyᵢ (Eq. 2)

where η is a learning parameter and M is the weights of the neuron. Hebbian learning is a “local” rule because the weights depend only on the input and output characteristics of an individual neuron. No other neurons are involved in determining its weights M, only the neuron yⱼ and its synapses xᵢ. However the prior art of Hebb, has several problems. One is that in Hebb's formulation weights can grow infinitely with repeated learning.

A novel version of Hebbian learning is described here that I call “cumulative average” Hebbian learning. Cumulative average Hebbian learning allows the memory weights to represent the average learned pattern which can be updated as new information becomes available.

The learning equation can be broken down into two components: the amount of previous synapse weight retention and the amount of new information retention. Both are governed by n. n represents the number of times the synapse has been exposed to new information or modified.

The equation governing the degree of synapse change given new information can be written as:

$$Δ {M}_{ij} = \frac{{x}_{i}}{{ny}_{j}} \qquad ( Eq . 3 )$$

The complete equation that governs the weights M(n) including the degree of previous information M(n−1)ᵢⱼ retention is as follows:

$${M ( n )}_{ij} = \frac{( n - 1 )}{n} {M ( n - 1 )}_{ij} + Δ {M}_{ij} = \frac{1}{n} {Σ}_{n} \frac{{x}_{i}}{{y}_{j}} \qquad ( Eq . 4 )$$

This is the cumulative average of trained examples and is completely local. Using this rule the weights of the synapse represent an average of the learning examples the neuron received. Thus the signals that repeatedly occur will be maintained within the weights. Spurious signals that may occur within one or two learning epochs will fade away.

The node simply reduces the plasticity of its synapse as a function of the number of times it has received a learning episode. This rule assures that the strength of connection does not boundlessly increase. Also if all the patterns are learned at once (in batch mode common for prior art) then equation 4 becomes a simple average of the training patterns μ(Y|X).

The degree of retention may change for different recognition criticality. This is motivated by the brain. For example neurons governed by a traumatic event such as those in the amygdala may retain more of the new information than previous information.

Since M represents expectation, any other method to obtain expectations can be used as a learning algorithm for the invention.

More forms of local learning can be achieved using additional possibilities such as manually setting characteristic prototypes.

Flexible Structure, Consolidation and Unsupervised Learning

Other methods of learning can be incorporated in a secondary learning phase including “unsupervised” “efficiency learning” and creating principal components or hierarchy based on overlapping prototypes.

The second phase is a consolidation-like phase which may occur offline (e.g. during sleep) in order to make recognition faster by building efficient hierarchies. In the invention hierarchy can be shown to reduce computation time and benefit from properties similar to feedforward networks (namely reducing overlap or increasing orthogonality). The more orthogonal neurons within a hierarchy are, the faster the processing time.

The recall nature of the invention allows easier evaluation of representations, modification of nodes, and thus makes it easier to evaluate overlap/orthogonally and build a hierarchy that avoids it. Because of these properties, the hierarchy can be grown in an ad-hoc manner without having a predetermined number of hidden nodes for every layer. For example a network can start as a single layer. Whenever two output neurons (or more) have a significant number of shared inputs, another node can be created below them (a new hidden node) that captures the shared inputs and makes the two neurons more orthogonal. Such a process can repeat and grow a hierarchy without pre-determining the number of hidden units ahead of time. Since memory of all of the invention is stored in local-type memory, the components of the hidden nodes are recallable, and the hierarchy architecture representing shared components can have logical recallable logical representations. The unsupervised learning proposed may also be merged with generalized Hebbian learning methods such as Sanger's Hebbian rule (Sanger 1989) to create principal components and hierarchy based on overlapping neurons. The extra phase allows Hebbian learning to be used for both supervised and unsupervised recognition and generate efficient hierarchical structures. However technically, if efficiency is not required (for example if there is an infinite amount of time to perform recognition) this phase may not be necessary.

The invention has been described for supervised training but is applicable to both unsupervised and supervised applications. Unsupervised methods do not have explicit labels and attempt to cluster data together.

Methods used to achieve unsupervised learning are varied. Some utilize neural networks while others “non-parametric” non-neural network methods.

For example, neural network-based unsupervised methods may use a mechanism of sparsity in order to limit the unsupervised outputs to a small number of classes. These methods also use feedforward recognition methodology: calculating Y node activities based on feedforward global weights W. Analogous unsupervised strategies that use feedforward methods can be created using feedforward-feedback instead or be created with prior art and converted.

Many non-parametric methods find centroids of clusters when they learn. During recognition, distances (e.g. hamming distance) between cluster centroids and the test pattern to be recognized is determined for all centroids. Some of these methods may have limitations ranging from not scaling well with large data, to only narrowly forcing a decision to one cluster at a time. Since the centroids can imitate a localist prototype, in certain cases, these centroids can be passed to the invention as prototype patterns for unsupervised nodes. In an embodiment, the optimization mechanism of the invention can then be used to determine whether data belongs to the various clusters. The optimization method can be faster than some of the distance measuring methods and more flexible in allowing mixtures of classes.

Symbolic and Discriminative Functions

Today's AI can be separated into two broad categories: Symbolic (Localist) and Discriminative (Feedforward) methods. Symbolic AI attempts to take in information build internal representations and answer logical questions. Discriminative AI attempts to recognize information from the environment: images, videos, speech. However Symbolic networks are poor at recognition and require lots of engineering, while discriminative which are feedforward networks are a black box, poor at logic and quick updating. With our feedforward-feedback approach we are building true AGI where the networks that can perform both like symbolic and discriminative AI.

Symbolic cognitive logic models that utilize recallable representations to model various cognitive tasks include but are not limited to: SHRUTI, LIDA, SOAR, ACT-R, CLARION, EPIC, ICARUS and ICL (e.g. Franklin and Patterson 2006; Laird 2008; Meyer and Kieras 1997; Shastri 2000; Poole 1997, 2008). These methods assume that sensory recognition is processed and recallable representations are available. The processed representations are often hand coded. This is because the most robust prior art feedforward recognition models are not recallable. Thus these cognitive models do not directly incorporate recognition. Without recall combined with recognition, this confines many these cognitive systems to less-satisfying examples with synthetic starting points. With the invention recognition and cognitive models can be better integrated.

A Symbolic connection can be thought of as the relationship between an input and the output node that does not depend on any other inputs and outputs. A symbolic example is for example, the relationship for zebra and legs, that it has 4 legs as previously discussed. A symbolic network is localist. The symbolic weight between zebra and legs remain the same regardless of other nodes. However, it is important for recognition that inputs will also be filtered by the amount of relevant information they contain (the inherent value of the input for correct recognition). This is why symbolic networks are not sufficient for recognition.

In feedforward networks, weights depend on input and output nodes other than the immediate input and output node that they connect. This is why error-driven discriminative learning is global learning and is a poor symbolic network. On the other hand symbolic weights cannot incorporate whether information is relevant, because relevance for recognition depends on whether other nodes use that information (and by definition symbolic information must be independent of other outputs).

However, it is necessary to determine relevance as part of recognition, thus the invention uses an optimization mechanism during recognition to determine how a relevant a piece of information is based on the other nodes that are currently active (e.g. the other animals that are also being considered) and modulates the relevance of the input (e.g. stripes) accordingly. The invention gets around the global-local, symbolic-discriminative conundrum by allowing the network to learn localist symbolic information but perform optimization during recognition to determine recognition like a discriminative (feedforward) network. Thus the invention allows the same network to function in a feedforward manner but also store information in a symbolic manner. The same end function (recognition) can be achieved as methods that include uniqueness information in memory weights by instead not including it (preserving symbolic relations) and determining uniqueness during recognition. This way Symbolic structure and insights are maintained.

In addition these insights can be used to convert memories from prior-art feedforward form to the invention's recallable form and from the invention's recallable form to the prior art feedforward form of weights. The recognition, recall, and symbolic properties are generalizable to hidden nodes as well. Even if nodes are hidden, they can still have either symbolic recallable weights or feedforward weights that include relevance.

Aspects of the invention can also display inference similar to “abduction” and explaining away (Pearl 1998).

The invention can achieve similar recognition results as global learning but has advantages of local learning such as the ability to recall. The invention provides neural network that functions both as Discriminative and Symbolic Networks.

Illuminating Regression Models and Display

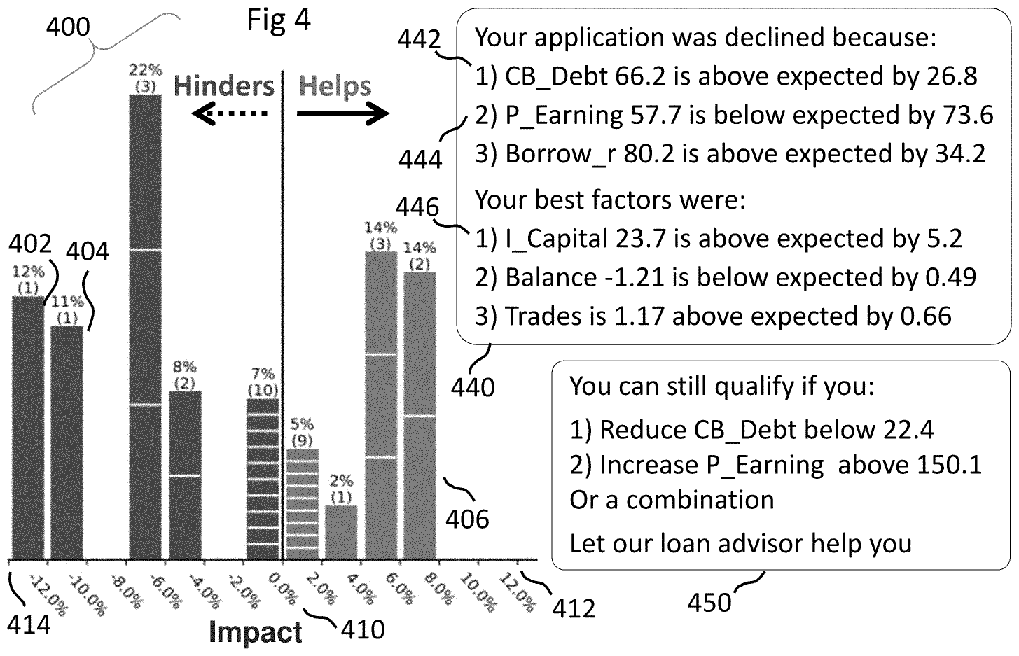

Embodiments hereof also work with Machine Learning (ML) regression models depicted in FIGS. 4-6. These models can be thought of as single node “networks”. Regression models have a threshold by which a decision is made. The output value they produce is compared to the threshold in order to determine whether a criteria is met or not. The converted invention maintains mathematically the same function and maintains the same criteria. However the invention provides more information about the decision.

We also developed graphing methods suitable for the information available from embodiments hereof. Demonstrations are shown of specific decisions based on a ML regression model with 30 factors converted and tested on several test data. The explainable AI features are graphed in FIGS. 4-6.

FIG. 4 shows a Weighted Impact-Histogram according to exemplary embodiments hereof which reveals how regression factors contribute to the decision. For every input run, all of the factors can be placed in the Histogram. This graph may be read as follows. Factors that fall on the zero (410) are the least impactful. The closer the factors are to zero, the less they are impactful. The more they appear to the right (412) the more they are helpful towards overcoming the decision threshold. The more they appear to the left (414), the less they contribute to the decision threshold.

In addition to the graphs, reports can be generated e.g. FIG. 4, item 440. Every item in 400 can be described in a report. For example the strongest inhibiting input factor CB_Debt (404) at −12% is elaborated in (442), the next hindering factor P_Earning (404) at −11% is elaborated in (444). The most helping input factor I_Capital (406) is elaborated in (446). The actual values the model expected and what the model received for these inputs are shown in the report.

With this information customer facing bankers can be equipped to justify, explain to regulators, and specify to customers reasoning the model used for its determination. Likewise, Data Scientists can debug, justify, explain to regulators, and to their managers the model design and rationale without reduction in predictions.

For example, in case of a declined loan application, a banker would be able have an insightful conversation with his client based on graph (400) and text (440) generated from the illuminated model. For example, “unfortunately your application has been declined. The reason is that your combination of an average credit score combined with a slightly high debt to income ratio did not satisfy our underwriting criteria. However, our model indicates that if you able to reduce your CB_Debt below 22.4, Increase your P_Earning above 150.1, or a combination you can still qualify.”

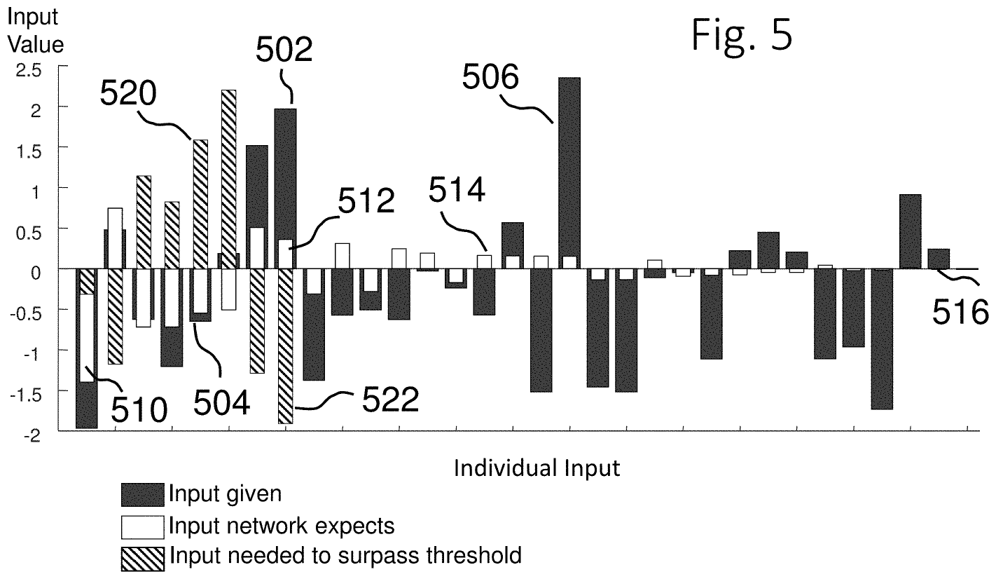

FIG. 5 shows more specific information in a non-histogram embodiments derived from the invention. Each bar represents one of the 30 inputs, and they are sorted by the absolute value that is expected by the model. The factor expected with the largest value is on the left (510). The factor with the smallest value should is on the right (516) but the value is so small it is not seen.

The different bar types represent:
1) What each input was (dark blue) see specific inputs (502, 504, 506).
2) What input value the network expects for each input (white) see specific input expectations (510, 512, 514, 516).
3) What corrective action that can be done using different inputs (stripes) see specific corrective values (520, 522).

In this case the result did not surpass threshold and the graph shows what changes can be done to surpass the threshold by factor.

For example the value for factor 8 was 2 (502). The model expected value of 0.4 (512). To surpass threshold by only changing factor 8, factor 8 value should be −1.9 (522).

This type of graph reveals the values for decision, the expected values and corrective values all at once.

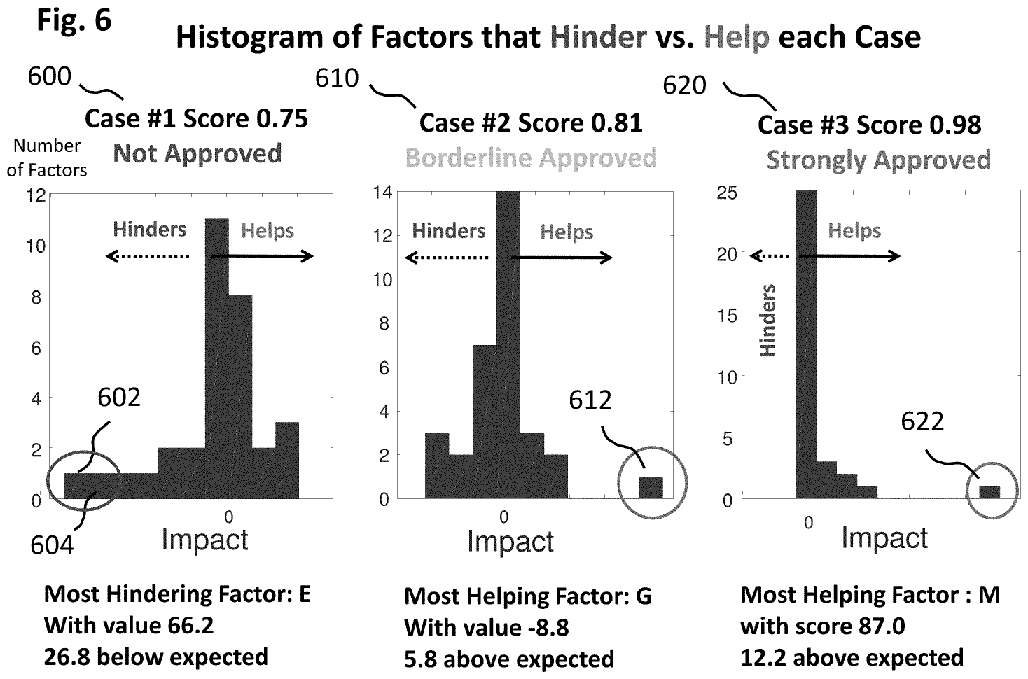

FIG. 6 shows the Impact-Histogram of three separate decisions (600, 602,604) each with a different result and distribution of factors. The Impact-Histogram graph (500) shows all 30 factors and where they fell between helping and hindering the decision. These graphs help quickly understand what factors were most important in each specific decision. The left (600) shows a case that is strongly rejected. The middle (602) a borderline case, and the right (604) a strong case for accept.

The two factors most inhibiting the left decision (600) can be clearly seen (602, 604) and their strength relative to the strongest factors supporting the decision.

For the borderline ‘yes’ decision (602) the total value from the black box model was 0.81 slightly over threshold of 0.80. Using the invention one can see there is only one factor (612) that is strongly causing the decision to go through.

Through the model, the borderline application, the case could be flagged for further review by management. With the proper explanations, management can better justify making an exception for a borderline ‘bad’ case or taking a closer look at a borderline ‘good’ before to provide final approval. If that factor is further analyzed by bankers and does not make sense to be solely relied upon, the bankers can make a more informed decision based on the information from this model.

### Further Applications

Invention embodiments are much broader than initial loan decisions. For example for banking applications many models are combined for different decisions in the bank. Initial models filter customers, others decide on price to charge, yet others monitor existing customer behavior and decide whether an existing customer will default.

The ability to understand models is very important for models that are based on each other like this. A good understanding of the models in the customer pipeline can help make design choices for the subsequent models in the path. For example based on knowing decision criteria for initial acceptance of a customer, subsequent models of prices to charge, and models predicting customer outcome can be better evaluated, debugged and designed.

Analogous models are made in other fields such as medicine, industry, government, law enforcement and so on: following customer, patient, product, and assembly line pipelines.

### Illuminating Deep Convolutional Networks

Convolutions are a way to create neural networks with specialized features that take advantage of pixel relationships within proximal spatial domains.

Convolution layers like neural network layers are composed of multiple outputs connected to multiple inputs except that the inputs are images within convolution planes. For example if a layer has 64 inputs and 128 outputs then it has 64 input images and 128 output images, performing 64×128=6,912 convolutions where each output image or channel is a sum of 64 input convolutions each created by multiplying the respective convolution filter through the input. Accordingly in illumination, each convolution can be converted and for each plane and can predict expected images. The sum of the planes can be used to predict the original inputs.

The steps of explanation are similar to steps of optimization. The feedback connections are used to predict expected patterns (752), and are compared with inputs (754). Mismatch between expected and inputs can be evaluated by subtracting or dividing the signal and reveal regions responsible for errors. In optimization this comparison is projected to the outputs to repeat the cycle during recognition.

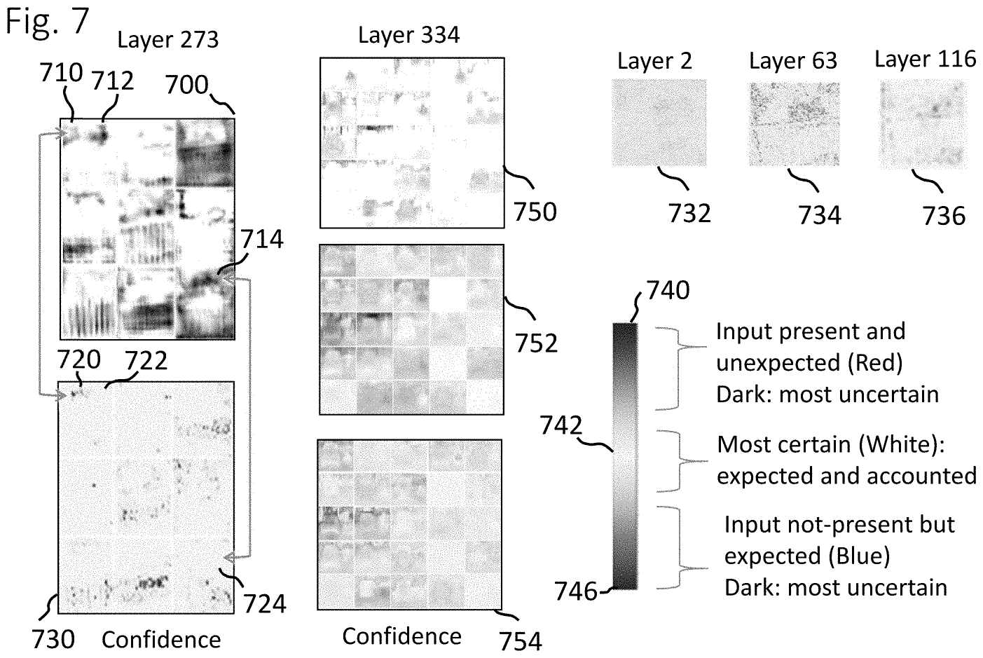

Embodiments hereof can also be implemented in feedforward deep convolutional networks used in visual processing. FIG. 7, shows explainability on a deep ResNet convolution neural network with 335 components. Two embodiments to provide explanations are:
1) Image explanation from the input layer to output using a test image, the invention performs recognition while evaluating which inputs and outputs were uncertain for recognition. The embodied display shows for each recognition specifically what parts of the inputs the network found most certain or uncertain. This information is represented by a color scale (740, 742, 746) which provides an indication of which part of the image may cause errors.
2) It is possible traverse backwards from outputs to inputs to reveal expected inputs for a label image in the output layer. An image label is assigned to the top layer convolution. The network is traversed backwards down the deep hierarchy from final output convolution to the input layer.

FIG. 7 shows uncertainty from various layers (730,754, 732, 734, 736) of the deep convolution. These figures representing inputs are a small subsection of the input channels which are displayed to show the fundamentals of the methods. For example (736) corresponds to layer 116 has 256 inputs and 512 outputs, confidence of one input is shown due to space. (730) corresponds to layer 272 which has 1024 input channels and 2048 outputs, of which 6 are shown due to space limitation. (750, 752, 754) corresponds to layer 334 which has 512 inputs and 38 outputs, where only 25 inputs are shown due to space limitations.

In each confidence image the colors indicate how certain each input is compared to what is expected (752). Dark red, indicates that the current input is unexpected (740). Dark blue indicates that an input was expected but not found (746). White (742) represents a region that is confident: expectations match inputs.

The region depicted (722) shows that its corresponding input region (712) is quite certain as that region is white (742). However right next to it in within the same picture the region (720) covered by input region (710) is not certain as can be seen by the dots of blue and red. This provides an indication of which part of the image may cause errors.

### Illuminating Time Domain (Recurrent and LSTM) Networks

Sequence learning using feedforward methods (for example Recurrent and LSTM networks) would require sequence data examples to be iid-rehearsed with fixed frequencies and in random order. Feedforward weights are learned and the same illumination process is possible for these networks. Same with forward and back in time and submodules in time processing features that learn weights W to compute Y=WX during recognition. Like convolutions, confidence in the sequences that each layer is looking for can be shown. Recurrent and LSTM models have several related components weights governing the learning. Each can be converted and shown.

### Additional Applications

Due to the central role of recognition and recall there are many applications in the scope, so much so that they cannot all be listed. An incomplete list includes: speech recognition, visual recognition, olfactory recognition, proprioception and touch recognition, infrared and recognition involving other bandwidths, multisensory recognition, text recognition, recognition of user trends, user behaviors in an operating system, learning stock market trends, learning robotic-movements, data mining, artificial intelligence, and so on.

Speech recognition applications like SIRI or its Google equivalent are good intuitive examples upon which to describe the improvements of the invention. Speech recognition is intuitive since most people understand speech and have encountered artificial applications such as SIRI or Google's equivalent of speech recognition. Because of the limitations on prior art, speech recognition based on prior art do not have the ability to add a new piece of data the on fly. Thus, although SIRI is able to recognize speech it is not possible for a user to add a new word. It is also not possible to modify a word that is recognized wrong (or is unique for the specific user). This is because based on the prior art, all of SIRI's data needs to be re-learned in order to add a new word. With SIRI based on the invention, a new word can just be added (possibly even right on the phone) whenever the user decides to add a new word.

Moreover, because memory can be recalled, it would be possible for SIRI based on the invention to recall and verbalize words in its memory. The user can then give feedback back to SIRI telling it how the word should ideally sound like (optimize for that user's speech, accent, ability, etc.). SIRI based on the invention can then modify the information in the memory. SIRI could even say the word modified in the memory again and get more feedback. In this way SIRI based on the invention can be better optimized for the user and have a more human-like interaction.

### Debug Tool for Developers or Regulators

The flexibility and recall are beneficial for developers of the application. Developers would be able to use the invention to debug and fine-tune internal memory.

Moreover, if developers desire, they can convert the memories within the invention into the form of prior art and use prior art recognition mechanisms. Developers can also take existing prior art memories and convert them to the memories of the invention. They can then use the recognition mechanism of the invention to view edit and test-run the memories in the invention form before they convert it back to the prior art form. Thus, the flexibility of the invention can allow developers greater flexibility even if ultimately prior art mechanisms are employed.

Another example of application is in an operating system like a telephone. The telephone can learn a user's behavior within an operating system predicting when best to conserve energy intensive application and predict how to optimize the operating system based on user's behavior. The invention provides an ability to quickly learn and update as the information arrives, use that data to recognize user behavior and optimize resources for the expected task, store that data in a database and study the intricacies of that behavior through recall

These improvements allow users or developers to more easily evaluate from the memory what it has learned, modify that information, or add new memory. This leads to faster development times, more interaction with users or developers and better optimization for the applications. It also provides other benefits including: a novel mechanism to guide attention during recognition, a method to convert from prior art-type memories to recallable and modifiable memories of the invention, and a method to convert memories from the invention to prior art. These improvements embody more optimized, flexible, and robust recognition.

### 2 Processes of Embodiments of the Invention

The invention uses symmetrical feedback which is inhibitory. Initially this architecture may be counterintuitive since nodes inhibit their own inputs. However this configuration implements an optimization mechanism (iteratively minimizing error) during recognition that converges. This optimization mechanism is not used to learn weights, it uses previously learned memories during recognition to find the important inputs for recognition and helps determine neuron activation.

In an embodiment of the invention, there are symmetrical feedforward-feedback connections and the feedback is negative (inhibitory). The weights can have any values. It performs equivalent recognition using feedforward-feedback weights as feedforward networks; using feedforward and feedback connections alternately in an iterative cycle creating optimization. The network and optimization can be shown to work with either subtractive inhibition or shunting (dividing) inhibition. Unlike a learning algorithm, optimization within the invention occurs during recognition and weights here are NOT learned via this optimization. Activation Y is determined by optimization and weights M are determined by expectation. The invention does not require optimization during learning and subsequently its learning is much easier. Moreover during recognition the current test pattern is available (while is not available during learning). This translates into better efficiency. In addition the fact that the memory stored does not have relevance incorporated within it makes its memories symbolic and recallable.

TABLE 1
Comparisons between feedforward
and feedforward-feedback methods

| | Structure During | Iterations | | |
|---|---|---|---|---|
| Method | Recognition | During | Weights | Relations |
| Prior Art | Feedforward | Learning | W | Global |
| Invention | Feedforward- | Recognition | M | Local |
| | Feedback | | | |

The invention does not require explicitly finding W and instead uses feedforward-feedback weights M. Optimization during recognition finds activation [symbol] , the same [symbol] that is found using feedforward weights W, but using M.

Hybrid Function Mode

Because they solve the same problem, a hybrid network (with both W and M) can be created that calculates recognition with feedforward but provides explanation with the feedback part. This allows the hybrid network to recognize without optimization but still be able to explain and be updatable through M (although for every update a new conversion from M to W is required).

Concrete Example of Learning and Recognition that Compares with Prior Art

The purpose of this example is to show that learning and recognition through M and the invention can achieve similar performance as learning through W using prior art, but learning through M can be simpler, faster, and more intuitive. Both a single-layer linear perceptron and the feedforward-feedback method are trained on the same learning data and tested on the same testing data.

Four hundred training data points were randomly generated and separated into two labels along by an artificial separator 840 (see FIG. 8C). This artificial separator separates random dots into two categories above the line 842 and below the line 844. The prior art and invention are both trained on this data. One hundred additional points are generated as test points for recognition tests and both methods are tested. Samples were rejected if they were too close to the separator. Both networks are initialized with random initial conditions, performance and computational resources are compared on a simple PC running Matlab.

Performance of the Feedforward Network

The prior art perceptron network is trained using iid rehearsal on the 400 samples until W is found where the number of errors on the training sample is 0. The learning rate was 0.5. A typical data set required about 6000 iterations and took about 18 seconds. Testing the perceptron on the 100 samples was very fast and required about 0.001 seconds or 0.00001 seconds per test. The perceptron did not have any testing errors (100%) as long as the learning and testing points did not fall on the separator. If they do fall close to the separator, the performance drops (% correct) and learning is slower.

Performance of the Feedforward-Feedback Algorithm

To determine the expectation matrix M from the training data, the cumulative average Hebbian learning to update was used to train. All of the black points above the line (depicted in 842) and all of the green points below the line (depicted in 844) were trained under two different labels. Calculating the M is not iterative and took only 0.02 seconds. The resulting values from one run are shown in matrix below.

| | | X₁ | X₂ | | | |
|---|---|---|---|---|---|---|
| M= | | 0.36 | 0.69 | | Y₁ | Black Label |
| | {open oversize bracket} | | | {close oversize bracket} | | |
| | | 0.66 | 0.33 | | Y₂ | Green Label |

Optimization using M was used for testing. The time and number of iterations were sensitive to the threshold value of d [symbol] used to stop the simulation. The simulation was stopped when Σd [symbol] <0.0001 and the identification of [symbol] was determined by the node within [symbol] with the highest value. Speed can be selected over accuracy by stopping earlier. Accuracy can be increased by stopping later. The time required was about 0.4 seconds for the 100 tests total or 0.004 seconds per test. The average number of iterations per test for this criterion was 21. The performance was analogous to the perception and also did not have any testing errors (100%) as long as the testing points did not fall on or very close to the separator. If they do fall close to the separator, the performance (% correct) drops and recognition is slower. This is analogous to the prior art feedforward algorithm.

Comparing Dynamics in Learning and Testing

The optimization of the prior art perceptron algorithm occurs during learning while the optimization implemented by the invention's feedforward-feedback architecture occurs during testing. The optimization dynamics take the most time, consume computational resources, and neither method was optimized for speed. The invention's feedforward-feedback method was about 900 times faster in learning. The perceptron was about 40 times faster in testing.

Looking at the combined computational costs for both training and testing, the feedforward-feedback took a total of 0.42 seconds. The feedforward perceptron method took a total of 18 seconds.

Beyond the test and training times, both methods performed similarly and both are governed by similar limitations (increased learning or processing time and more errors if test points are close to the separator).

Multiclass Classification

Further testing was done with multiclass recognition (recognition with more than two nodes) using randomly generated pattern sets with arbitrary input-label patterns. We tested networks with hundreds of thousands inputs and thousands of output nodes. As long as the patterns are separable, when a characteristic pattern is presented, the networks correctly identify the patterns.

Since recognition and recall are essential in a broad scope of computer applications the scope is essentially boundless. Applications include and not limited to: Simplest households devices, computer programs, smartphone apps, voice or text recognition, operating systems, financial trend monitoring and learning, self-driving cars, control systems, monitor systems, e.g. for NASA, robotic applications and control, self-learning, artificial intelligence, data mining, models of the brain recognition.

The invention provides significant improvements for recognition with flexible learning, and allows recall necessary for a broad scope of applications including computer applications, artificial intelligence and brain modeling applications.

### CONCLUSION

While this invention has been described in terms of several preferred embodiments, there are alterations, permutations, and equivalents, which fall within the scope of this invention. Although various examples are provided herein, it is intended that these examples be illustrative and not limiting with respect to the invention.

It is understood by a person of ordinary skill in the art, upon reading this specification, that any or all of the features of the embodiments described or otherwise may be combined in any fashion, sequence, order, combination or any combination thereof.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

I claim:

1. A computer-implemented method comprising:
obtaining a first neural network trained to recognize one or more patterns;
converting said first neural network to an equivalent second neural network; and
using at least said second neural network to determine one or more factors that influence recognition of a pattern by said first neural network.

2. The method of claim 1, wherein the first neural network is a multilayered network comprising a plurality of layers.

3. The method of claim 2, wherein the second neural network comprises the same number of layers as the first neural network.

4. The method of claim 1, wherein the first neural network comprises a feedforward network.

5. The method of claim 1, wherein the second neural network comprises a feedforward-feedback network.

6. The method of claim 1, wherein
the first network includes a first number of input modules, a second number of output modules, and a third number of feed-forward connectors, and wherein
the second neural network includes a fourth number of input modules, a fifth number of output modules, and a sixth number of feed-forward/feedback connectors,
wherein the first number is equal to the fourth number, and the second number is equal to the fifth number, and the third number is equal to the sixth number.

7. The method of claim 1, wherein the first network includes a seventh number of nonlinearities between layers of the first network, and wherein the second neural network includes an eighth number of nonlinearities between layers of the second neural network, and wherein the seventh number is equal to the eighth number.

8. The method of claim 1, wherein said converting comprises:
for each connection of the first network having a feedforward weight, forming, in the second neural network, a corresponding connection having a corresponding feedforward-feedback weight pair.

9. The method of claim 1, wherein said using comprises:
using the second neural network's weights to iterate between feedforward and feedback until recognition of said pattern is complete, producing a desired recognition state.

10. The method of claim 9, wherein said using further comprises:
using the first network's weights to perform recognition of said pattern.

11. The method of claim 9, further comprising:
determining expected input activity using said desired recognition state and one or more weights on said second neural network.

12. The method of claim 9, further comprising:
determining an expected pattern for a particular node.

13. The method of claim 1, wherein said using comprises determining one or more of:
(i) one or more expected inputs that were not found; and
(ii) one or more present inputs that were not expected.

14. The method of claim 1, wherein the second neural network comprises:
one or more input modules, one or more output modules, and one or more feed-forward connectors, and one or more feedback connectors,
wherein said one or more input modules are each adapted: (a) to receive and store input information received from sensors, (b) to receive back-transmitted output information from one or more feed-back connectors, (c) to modulate the input information using back-transmitted information to form modulated input information, (d) to forward-transmit the modulated input information using said one or more feed-forward connectors to said one or more output modules;
wherein said one or more output modules are each adapted: (a) to store output information as stored output information, (b) to receive modulated input information forward-transmitted by one or more feed-forward connectors, (c) to modulate the stored output information using forward-transmitted information received from one or more feed-forward connectors, (d) to store the modulated output information as output information, and (d) to back-transmit the modulated output information using one or more feed-back connectors to said one or more input modules;
wherein each of the one or more feed-forward connectors modifies and transmits modulated input information as forward-transmitted information from one of the one or more input modules to one of the one or more output modules, and wherein each feed-forward connector is associated with a feed-forward connector weight used to modify the information transmitted; and
wherein each of the one or more feed-back connectors modifies and transmits modulated output information as back-transmitted information from one of the one or more output modules to one of the one or more input modules,
wherein each of the feed-back connectors is associated with a feed-back connector weight that is used to modify the information transmitted.

15. The method of claim 1, wherein the second neural network is mathematically equivalent to the first neural network.

16. A recognition device having hardware, including at least one processor and associated memory, the device comprising:
a network including one or more input modules, one or more output modules, and one or more feed-forward connectors,
wherein said one or more input modules are each adapted: (a) to receive and store input information received from sensors, (b) to receive back-transmitted output information from one or more feed-back connectors, (c) to modulate the input information using back-transmitted information to form modulated input information, (d) to forward-transmit the modulated input information using said one or more feed-forward connectors to said one or more output modules;
wherein said one or more output modules are each adapted: (a) to store output information as stored output information, (b) to receive modulated input information forward-transmitted by one or more feed-forward connectors, (c) to modulate the stored output information using forward-transmitted information received from one or more feed-forward connectors, (d) to store the modulated output information as output information, and (d) to back-transmit the modulated output information using one or more feed-back connectors to said one or more input modules;
wherein each of the one or more feed-forward connectors modifies and transmits modulated input information as forward-transmitted information from one of the one or more input modules to one of the one or more output modules, and wherein each feed-forward connector is associated with a feed-forward connector weight used to modify the information transmitted; and
wherein each of the one or more feed-back connectors modifies and transmits modulated output information as back-transmitted information from one of the one or more output modules to one of the one or more input modules,
wherein each of the feed-back connectors is associated with a feed-back connector weight that is used to modify the information transmitted.

17. The recognition device of claim 16, where completion of operations comprises a cycle, and wherein the device repeats these cycles, and wherein the recognition device is further constructed and adapted:
to calculate a state of a current cycle with a component to sum one or more of:
(i) the input module modified information for all inputs; and/or
(ii) the output module modified information for all outputs; and/or
(iii) the module modified information; and
to store the state of the current cycle; and
to compare the state of the current cycle with a stored state of a previous cycle; and
to stop the device if a change between the state of the current cycle with a stored state of a previous cycle is less than a threshold.

18. The recognition device of claim 16, further constructed and adapted to store weights of feedback connectors that back-transmit information from an individual output module, wherein said stored weights are is used to indicate sensor input values suited for that individual output module.

19. The recognition device of claim 16, further constructed and adapted:
to calculate a sum of the back-transmitted output information received by an individual input module,
to compare input information received by sensors of the same input module with the sum of the back-transmitted output information,
to determine if a first sum of the back-transmitted output information received is greater than sensor information, and, based on whether the first sum of the back-transmitted output information received is greater than sensor information, to indicate that an input was expected and not adequately found in the sensors,
to determine if a second sum of the back-transmitted output information received is less than sensor information, and, based on whether the second sum of the back-transmitted output information received is less than sensor information, to indicate that an input was not expected in the sensors, and
to determine if a third sum of the back-transmitted output information received is equivalent to sensor information, and, based on said third sum of the back-transmitted output information received is equivalent to sensor information, to indicate that an input was expected and found in the sensors.

20. The recognition device of claim 16, further constructed and adapted:
to learn or modify (a) an existing association, or (b) add a new recognition category with a new output node, or (c) add a new input sensor modularly, without modifying existing weights of the device that do not directly connect to the new input sensor or new output node, and
to modify an existing forward-transmitting connector from input and its associated existing back-transmitting connector with an updated association; and/or
to add a new non-existing output module with (a) associated new forward-transmitting connector from input (b) associated new back-transmitting connector to same input; and/or
to add a new input node with (a) associated new back-transmitting connector from output (b) associated new forward-transmitting connector to same output.

21. The recognition device of claim 16, further comprising:
a labeled data set with associated input patterns, wherein:
data for each label is averaged to form a calculated average, and
an output node is created for each label, and
weights of feedback and feedforward mechanisms transmitting between that output node are determined by the calculated average.

22. The recognition device of claim 16, comprising:
a first layer which receives inputs from sensors,
one or more intermediate layers which receive a output of a previous layer as sensor input for the intermediate layer, and
a top layer that serves as outputs of the network.

23. The recognition device of claim 22, wherein:
the inputs are arranged in a manner that allows a smaller array of inputs to spatially sample a subspace of a larger input set, and wherein
the smaller array is repetitively tiled throughout a larger array of inputs, and wherein
the next layer is used to tile spatial inputs.

24. The recognition device of claim 23, comprising:
a connection to transmit modulated input information from the layer above to the output module of the layer below using one or more feed-back connectors, wherein
output modules of the layer below modulate the output information based on information obtained from one or more feed-back connectors form the input layer above.

25. The recognition device of claim 24, wherein one or more inputs or layers are configured in a manner to allow recognition of movement or sequences in time.

26. The recognition device of claim 25, wherein one or more layers delay processing in time to retain activation of a previous state, and wherein
one or more layers with input sensors combine retained activation of one or more layers representing delayed information.

27. An article of manufacture comprising non-transitory computer-readable media having computer-readable instructions stored thereon, the computer-readable instructions including instructions for implementing a computer-implemented method, said method operable on a device comprising hardware including memory and at least one processor and running a service on said hardware, said method comprising the method of claim 1.

28. A system comprising:
(a) hardware including memory and at least one processor, and
(b) a service running on said hardware, wherein said service is configured to:
perform the method of claim 1.
